(19) United States
(12) Patent Application Publication
(10) Pub. No.: US 2026/0330208 A1
(43) Pub. Date: Oct. 22, 2026

(54) SPATIALLY COLLABORATIVE TELEASSISTANCE OR TELEOPERATION SESSIONS FOR PHYSICAL AI DEPLOYED IN REAL WORLD ENVIRONMENTS DURING TRAINING AND OPERATIONS

(71) Applicant: Dorian Cartwright, San Jose, CA (US)

(72) Inventor: Dorian Cartwright, San Jose, CA (US)

(21) Appl. No.: 19/546,320

(22) Filed: Feb. 21, 2026

(51) Int. Cl. G06N 3/063; G06N 3/08

(52) U.S. Cl. CPC G06N 3/063; G06N 3/08

(57) ABSTRACT

Spatially collaborative teleassistance and teleoperation of a physical AI unit (e.g., a humanoid robot or autonomous vehicle) deployed in a real-world environment. The system utilizes a remote AI control node comprising an AI agent, such as a Large Language Model (LLM) or Retrieval-Augmented Generation (RAG) system, communicatively coupled to the physical AI unit via a data network. A prompt enhancement engine converts multi-modal sensor data—including visual, acoustic, and haptic inputs from the physical AI's environment—into semantic text tokens that are injected into a structured system prompt. This allows the remote AI agent to generate context-aware training scenarios and remotely control the on-site unit by issuing simulated human commands that mimic human controls, such as synthetic voice, simulated joystick movements, and simulated iris gaze data. The architecture integrates robotics simulation and physics engines (e.g., NVIDIA Isaac and Cosmos) to ground the AI agent's logic in reality, enabling a hybrid operation mode that bridges the gap between simulation and real-world deployment (Sim2Real) through real-time, multi-modal feedback lo

[symbol]

### FIELD OF THE INVENTION

The present disclosure relates generally to Physical AI, and, more particularly, to interactive AI Agent and human-in-the-loop training and post-training operation of Physical AI.

### BACKGROUND

Modern Physical AI, such as humanoid robots, autonomous vehicles and wearable AR/VR glasses, often require sophisticated training methods to bridge the gap between simulation and real-world deployment (Sim2Real). When it comes to Digital AI, relying mainly upon text data and digitally-contained environments, the Internet provides a wide range of training corpus to accurately model.

However, when it comes to Physical AI deployed in the real world, conventional systems are unable to effectively train due to a lack of available real world training data.

Thus, there a need for robust techniques during training and normal operations of Physical AI.

### SUMMARY

To address these shortcomings, systems, methods and software program products provide spatially collaborative teleassistance and teleoperation sessions for Physical AI in real world environments, during training and normal operations.

In various embodiments, one mode of operation involves AI Agent-to-Physical AI Telepresence or Teleoperation, where a remote AI Agent controls an on-site Physical AI unit by issuing Large Language Model (LLM)-generated “simulated human” commands, such as synthetic voice and gaze data, or provides on-site assistance to a human wearing Physical AI. A second mode focuses on Human-to-Physical AI Telepresence or Teleoperation, enabling an office user to control an on-site robot or drone through voice commands and iris detection for gaze fixation. A third mode facilitates a collaborative spatial session where both an office user and an AI Agent can control an on-site unit, with the AI acting as a proactive “third participant” that automatically retrieves LLM-generated data and provides simulated human commands to assist the interaction.

In another embodiment, to enhance performance, the system may utilize a Prompt Enhancement Engine that intercepts raw visual, acoustic, haptic and Inertial Measurement Unit (IMU) sensor data and converts it into semantic “tokens” for the LLM. This process ensures the AI model receives a structured, context-rich “System Prompt” instead of a raw query, which improves inference accuracy and safety. Additionally, Sim2Real testing for the Physical AI can be overseen by a human or a simulated human AI agent.

### BRIEF DESCRIPTION OF FIGURES

In the following drawings, like reference numbers are used to refer to like elements. Although the following figures depict various examples of the invention, the invention is not limited to the examples depicted in the figures.

FIG. 1 is a schematic diagram illustrating a system for AI Agent and Human-to-Physical AI deployed in the field with a remote Telepresence or Teleoperation, according to an embodiment.

FIG. 2 is a block diagram illustrating an AI Agent of FIG. 1 integrated within a training stack for Sim2Rreal deployment in the field, according to an embodiment.

FIG. 3 is a block diagram illustrating internal software components of the AI Agent for AI training and AI inferencing, according to an embodiment.

FIG. 4 is a block diagram illustrating a computing device for AI training, according to an embodiment.

FIG. 5 is a flow chart illustrating a method for training Physical AI in the field with a remote teleoperation, according to an embodiment.

FIG. 6 is a flow chart illustrating a step for training Physical AI with human mimicked commands, from the method of FIG. 5, according to an embodiment.

FIG. 7 is a flow chart illustrating a step of generating synthetic Physical AI training data from real world deployment inputs, from the method of FIG. 5, according to an embodiment.

### DETAILED DESCRIPTION

The description below provides methods, computer program products with non-transitory mediums storing computer-executable code (e.g., source code), and systems. The following description, as understood by one of ordinary skill in the art, can be applied to many variations not explicitly disclosed herein, in the interest of conciseness.

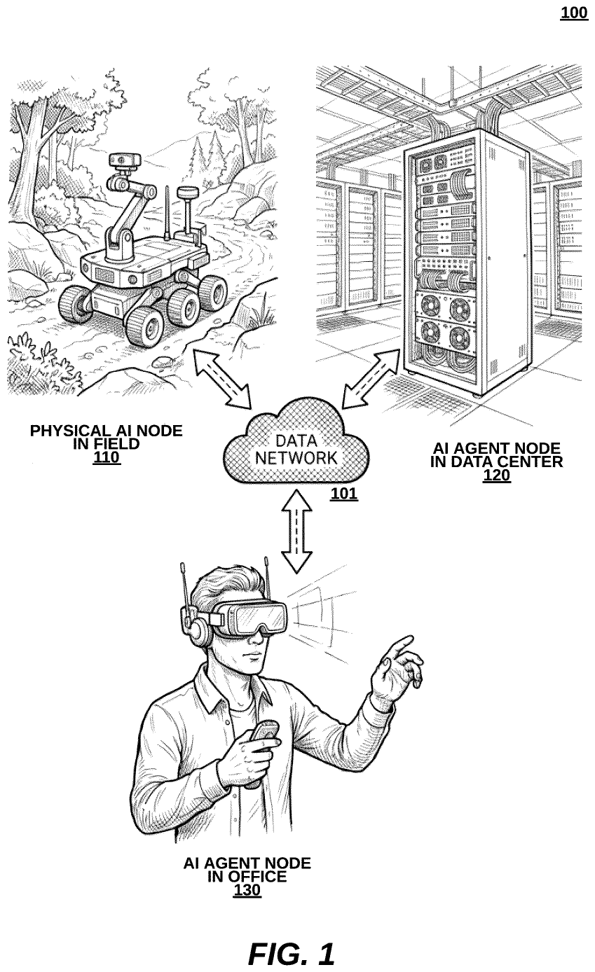

### I. System for Physical AI With Remote Telepresence or Teleoperation (FIGS. 1-4)

### A. System Components

FIG. 1 is a schematic diagram illustrating a system for AI Agent and Human-to-Physical AI in the field with a remote Telepresence or Teleoperation, according to the embodiment. More specifically, a data network enables a real-time conference session between a Field Node, an Office Node and an AI control Node:
Field Node: A smart glasses device worn by human or an autonomous Physical AI Unit (e.g., stationary or mobile robot, humanoid robot, air or sea drone, or land-based autonomous vehicle) equipped with multimodal sensors (e.g., visual, acoustic, haptic, IMU), and the like.
Office Node: A remote terminal (e.g., virtual reality (VR) or augmented reality (AR) headset) worn by a human and equipped with internal eye-tracking sensors (e.g., iris detection) and microphones.
AI Control Node: An AI Agent including a Large Language Model (LLM), and in some cases, a RAG Engine, and a “Simulated Human” module to create eye-tracking and audio.

In some embodiments, all three nodes join and are synchronized over a single session, although there can be multiple Physical AI, multiple AI Agents and/or multiple Humans as well. Other embodiments include two nodes. Still another node includes allow a session between the Physical AI Node and a Human Node, however, because an AI Agent is able to mimic humans, an AI Agent Node can initiate operate over the Physical AI Node and Human Node automatically and without reconfiguration and without manual intervention.

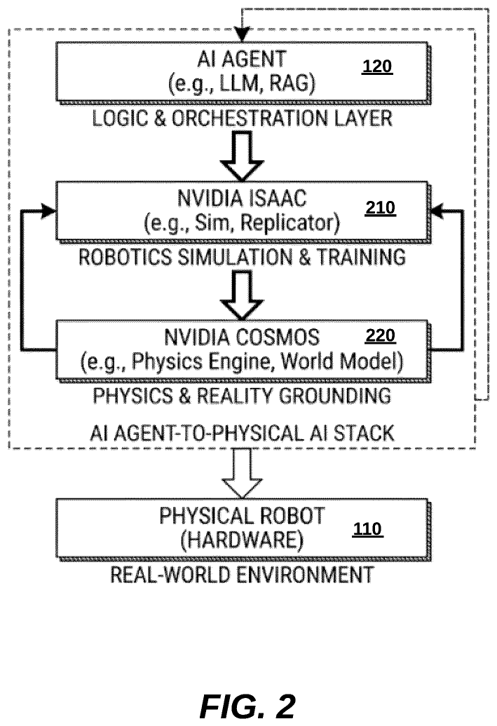

FIG. 2 is a block diagram illustrating an AI Agent 120 integrated within a training stack for Sim-to-Real deployment in the field. The architecture begins with a logic and orchestration layer that includes the AI agent 120, which may utilize a Large Language Model (LLM) and Retrieval-Augmented Generation (RAG).

Below this is a robotics simulation and training layer utilizing tools, such as NVIDIA ISAAC 210, which handles simulation and replicator functions. This layer connects to a physics and reality grounding layer featuring NVIDIA COSMOS 220, acting as the physics engine and world model. Together, these components form an AI agent-to-physical AI stack. This stack outputs to a physical robot (hardware) 110 to enable operation within a real-world environment. Many other variations are possible.

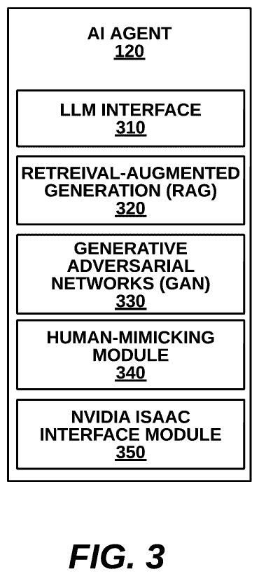

FIG. 3 is a block diagram illustrating internal software components of the AI Agent 120 utilized for AI training and inferencing. The AI Agent 120 includes an LLM interface 310 to process language and semantic inputs. It further comprises a Retrieval-Augmented Generation (RAG) module 320 for cross-referencing contextual data and manufacturer specifications, along with a Generative Adversarial Networks (GAN) module 330. To enable the remote control of physical units by mimicking human operators, the AI Agent 120 utilizes a human-mimicking module 340 capable of generating synthetic voice commands and simulated iris gaze data. Additionally, an NVIDIA ISAAC interface module 350 is included to seamlessly connect the agent to high-fidelity, physics-based simulation environments.

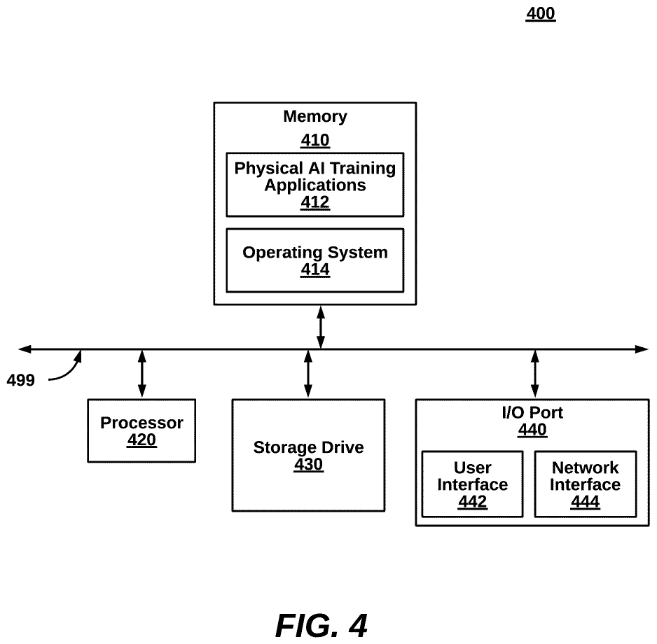

FIG. 4 is a block diagram illustrating a computing device 400 suitable for AI training and executing the methods described herein. The computing device 400 features a system bus 499 that communicatively couples its internal components. A processor 420 is connected to the bus 499 alongside a memory 410. The memory 410 stores an operating system 414 and specific physical AI training applications 412. The computing device 400 also includes a storage drive 430 for data retention. External communications and user interactions are handled via an I/O port 440, which includes a user interface 442 and a network interface 444 for connecting to the data communication network. The computing device 400 is a general processor-driven architecture that can be implemented by the AI Agent 110, the Physical AI 120, and the human attended computing device 130.

The processor 420 can be a Graphical Processing Unit (GPU), a Tensor Processing Unit (TPU), a neural processing unit, a network processing unit, a Central Processing Unit (CPU), an Application-Specific Integrated Circuit (ASIC), an Field Programmable Gate Array (FPGA), or any other appropriate processing unit. The semiconductor chips may be manufactured by Nvidia, AMD, Intel, Carebras, Qualcomm, Broadcom, ARM, or the like. Some embodiments are specialized for AI training and/or AI inferencing. Various implementations have one chip, while others have multiple connected chips. Data centers can specially house and utilize numerous cooperating computing devices 400.

Sensors can be integrated with the computing device 400. For instance, a humanoid robot can have a video camera, a microphone, haptic sensors, actuator sensors, GPS, thermometers, IoT devices, and the like.

### B. Use Cases

### Embodiment 1: AI Agent-to-Physical AI Telepresence or Teleoperation

In this mode, a remote AI Agent controls the on-site Physical AI. The remote AI Agent uses synthetic command generation for observing and controlling the Physical AI by mimicking human inputs. It generates synthetic voice commands and iris data in response to real-time feeds from the Physical AI.

One of the most significant hurdles in the deployment of Physical AI is the “Sim-to-Real” challenge. Because it is often too dangerous or slow to train a robot entirely in the real world, these systems are initially trained in hyper-realistic digital simulations (e.g., using a digital twin). The present techniques utilize seamlessly bridge this gap. Telepresence and teleoperation allow human and/or AI Agent input to guide the Physical AI during real world situations, which helps customize the training of the Physical AI. Further, the training platform to utilize the exact same control interfaces designed for human operators, eliminating the need for separate control APIs during the simulation phase.

Furthermore, during this real world training, the system can intentionally generate simulated analog sensor anomalies. The Multimodal Prompt Enhancement Engine tokenizes this simulated physical sense data into semantic text tokens. For example, simulated acoustic frequency anomalies or haptic vibration changes are converted into corresponding tokens and injected into the structured system prompt. In more detail, if a field user teleoperating a robot touches an industrial motor, the robot's IMU detects an abnormal vibration profile. The engine translates this physical feedback into a semantic token, such as [HAPTIC_TOKEN: “Oscillation: Severe”]. By repeatedly exposing the AI model to these synthetic tokens and mapping them to the generated simulated human inputs, the system effectively teaches the Physical AI how to react to the dynamic, unpredictable physical world before physical actuation is ever required.

In another implementation a human is wearing Physical AI during activities, such as repairing an HVAC system, flying an airplane, assembling a newly purchased furniture item, writing a document or coding software on a personal computer, and the like. The AI Agent is able to train bused on multi-sensory data sent upstream, or assist in future activities based observed ones.

### Embodiment 2: Human-to-Physical AI Telepresence or Teleoperation

In this mode, an Office User observes of teleoperates an on-site Physical AI. At times, the physical AI operates autonomously with Office User observance during the session, and at other times, the Office User take full or partial control. Multi-modal prompts from the Office User can be enhanced as inputs processed by an LLM that outputs instructions to the Physical AI. The Office User wears an AR/VR headset that tracks their eye. If the Office User looks at a specific valve on the live video feed, the system interprets this as a command to Focus Attention Here. The Office User issues natural language commands. The system combines the voice command with the iris gaze coordinate to execute the task precisely on the specific object the user is looking at.

### Embodiment 3: AI Agent and Human-to-Physical AI Telepresence or Teleoperation

In this collaborative mode, the Field User, Office User, and AI Agent coexist in a shared session. The AI Agent passively monitors the conversation between the two humans. If the Office User mentions a specific part, the AI automatically retrieves the schematics and displays them to both users. In some cases, the AI agent can actively participate in the conversation. For example, the AI Agent can monitor for safety violations, or other policy-based guardrails, using the Prompt Enhancement Engine and can interject with visual warnings visible to both human users.

C. Physical AI Multimodal Prompt Enhancement Engine

Physical AI generally refers to the integration of artificial intelligence into human physical bodies, such as glasses, earpieces, human-embedded compute, and other wearables. It also can refer to robots, drones, and autonomous vehicles—enabling them to sense, reason, and interact with the real world in real-time. While traditional digital AI operates purely in the digital realm of text and images, Physical AI deals with embodied intelligence, translating digital thinking into physical doing by understanding the laws of physics, spatial awareness, and tactile feedback. To function effectively in the real world, a Physical AI system typically relies on three interconnected layers: sensing, reasoning, and actuation. The sensing layer perceives the environment using inputs such as video cameras, microphones, LiDAR, and IoT devices. The reasoning layer processes this sensor data using neural networks for centralized data center LLM inferencing and edge inferencing to predict outcomes and plan movements. Standard, deterministic software and general processing units can also assist intelligent components. Finally, the actuation layer sends signals to physical components like motors and joints to perform specific tasks.

### 1. Physical AI Model Training Data Stack

For Physical AI training, a robot can use a base layer of training data available on the Internet and human videos (e.g., YouTube or proprietary database). A middle layer of synthetic reality involves high volumes of synthetic data generated in simulation, enhanced by tools like Nvidia Isaac Sim, Omniverse and Newton physical engine to create virtual worlds for the robot to train in. The middle layer can relate to a digital twin for training in virtual environments. At a top layer of real-world grounding, a smaller, high-value set of real-world demonstration data helps transfer the modeled skills to the physical world. In some embodiments, an interface to the Human-to-Physical AI or AI Agent-to-Physical AI modes of the present system are integrated with APIs to a robot training stack.

To address real world challenges and bridge the sim-to-real world gap, the AI Agent-to-Physical AI mode is able to generate highly-valuable real world training without human intervention. The real world data can be greatly enhanced by generating synthetic data from scenarios, for the subject robot and stored to a database for subsequent training of other robots. Some embodiments of the system's reasoning and sensing layers are designed to integrate seamlessly with high-fidelity, physics-based simulation environments, such as Nvidia's Omniverse or Isaac Sim. By utilizing AI Agent-to-Physical AI real-world synthetic data within these hyper-realistic simulation platforms, the physical constraints of the AI can be rigorously trained before physical deployment, using the real world and extended data generation.

To implement human-mimicked commands, Isaac GROOT is a high-performance, open-sourced model specifically for general-purpose humanoid robots that enables processing of natural language instructions from the AI Agent-to-Physical AI layer. Jetson Thor can be implemented as an onboard computer to handle multimodal AI workloads required by humanoid robots to actuate human-mimicked commands. Vision-Language-Action (VLA) models can bridge the gap between seeing an environment and executing precise physical movements.

In one implementation, a robot receives visual, audio and haptic inputs. A human instruction to “Pick up the round object and place in yellow bin” is received and encoded into text tokens, along with an image or video that is encoded into image tokens for processing by a Vision-Language Model (VLM) (e.g., Nvidia Eagle-S VLM), at a low frequency (e.g., 10 Hz). A robot state including base positions, joint positions, joint velocities and EEF posses is also encoded into action tokens for a Diffusion Transformer (DiT), at a fast frequency (e.g., 120 Hz). Finally, the DiT can receive input from the VLM to ensure consistency with the task before translating inputs to one or more motor actions for the robot.

Furthermore, the architecture supports broad enterprise orchestration frameworks, mapping directly to systems like Microsoft Azure IoT Operations and Agent 365. This compatibility allows the system to treat autonomous physical AI units as managed enterprise operators, translating high-level logical intent directly to physical actuation via simulated human inputs without requiring custom-coded application programming interfaces (APIs) for individual robot hardware.

To process the complex, multi-modal environment, the system utilizes various input modalities with specific technical purposes. Acoustic inputs from MEMS microphones detect frequency anomalies, such as motor grinding, while vibrational data from accelerometers identifies misalignments through physical feedback. Visual data from RGB and depth cameras tracks tool placement and identifies object models, and contextual data via a Retrieval-Augmented Generation (RAG) engine cross-references current sensor states with manufacturer specifications. Prior to submitting these in-operation queries to the LLM, the system can utilize a Prompt Enhancement Module to increase inference accuracy and safety. This module performs critical pre-submission tokenization of the raw analog physical sense data into semantic text tokens. For example, visual object detection tags, acoustic Fast Fourier Transform (FFT) frequency conversions, and haptic vibration data are all translated into respective semantic tokens. The module then constructs a structured system prompt that wraps the user's simple query, injecting these semantic tokens to provide contextual weighting, such as detected objects and sensor layers. Finally, the Prompt Enhancement Module executes safety guard railing. If danger tokens are detected within the semantic data, the system automatically prepends a stop-work command to ensure physical safety.

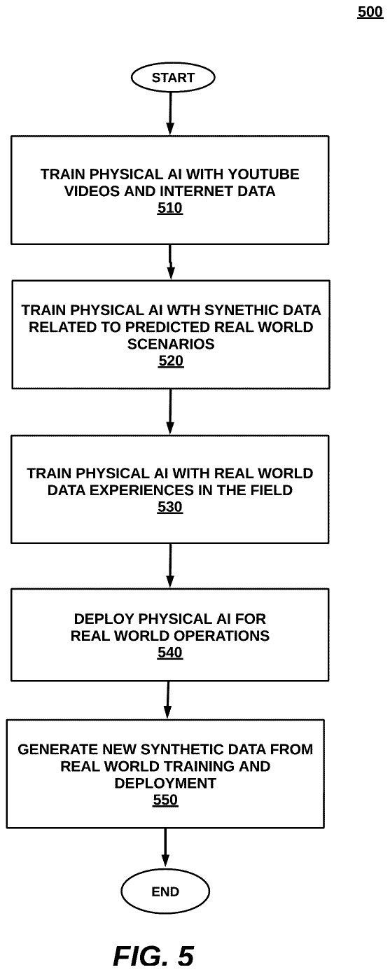

### II. Methods for Physical AI with Remote Telepresence or Teleoperation (FIGS. 5-7)

The following methods include steps that are merely example implementations. There can be more or fewer steps, and steps can be reorganized into different orders.

FIG. 5 is a flow chart illustrating a method 500 for training a Physical AI in the field with a remote teleoperation. The method begins at step 510, where the system trains the physical AI with YouTube (or other public platform or proprietary database) and Internet data. Next, at step 520, the physical AI is trained with synthetic data related to predicted real world scenarios. Then, at step 530, the physical AI is trained with real world data experiences in the field. Following these training phases, at step 540, the physical AI is deployed for real world operations. Finally, at step 550, the system generates new synthetic data from the real world training and deployment to complete the cycle.

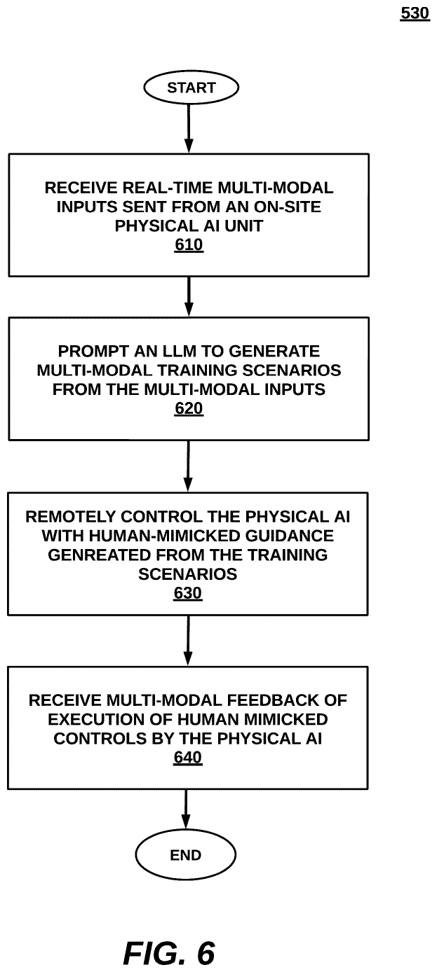

FIG. 6 is a flow chart illustrating the step 530 for training the physical AI with human mimicked commands, detailing the processes occurring from the method 500 of FIG. 5. First, at step 610, the system receives real-time multi-modal inputs sent from an on-site physical AI unit. At step 620, the system prompts an LLM to generate multi-modal training scenarios from the received multi-modal inputs. Subsequently, at step 630, the physical AI is remotely controlled with human-mimicked guidance generated from those training scenarios. Lastly, at step 640, the system receives multi-modal feedback regarding the execution of the human mimicked controls by the physical AI.

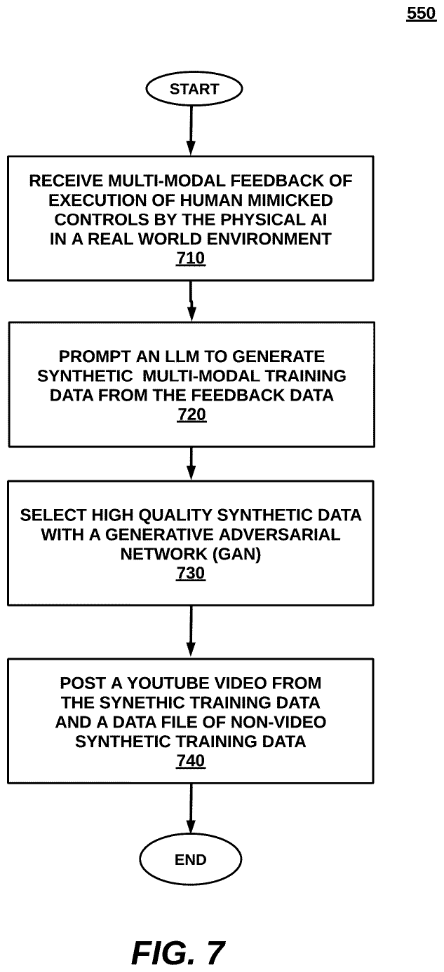

FIG. 7 is a flow chart illustrating the step 550 of generating synthetic Physical AI training data from real world deployment inputs, expanding upon the method 500 of FIG. 5. At step 710, the system receives multi-modal feedback concerning the execution of human mimicked controls by the physical AI operating within a real world environment. Next, at step 720, an LLM is prompted to generate synthetic multi-modal training data derived directly from the feedback data. At step 730, the system utilizes a Generative Adversarial Network (GAN) to select high quality synthetic data. Finally, at step 740, the system posts a video to YouTube (or other public platform or proprietary database) created from the synthetic training data alongside a data file containing non-video synthetic training data.

### III. Generalities of the Disclosure

This description of the invention has been presented for the purposes of illustration and description. It is not intended to be exhaustive or to limit the invention to the precise form described, and one of ordinary skill in the art will recognize many modifications and variations are possible in light of the teaching above. The embodiments were chosen and described in order to best explain the principles of the invention and its practical applications, in a concise manner. This description will enable others skilled in the art to best utilize and practice the invention in various embodiments and with various modifications as are suited to a particular use.

The scope of the invention is defined by the following claims.

I claim:

1. A multimodal physical artificial intelligence (AI) system configured for human-mimicking teleoperation of physical AI, comprising:
an on-site physical AI unit comprising a first processor and an interface configured to receive and execute multi-modal human inputs, wherein the multi-modal human inputs comprise voice commands and iris gaze fixation data; and
a remote AI control node comprising a second processor and executing a remote AI agent, wherein the remote AI agent is configured to control the on-site physical AI unit by mimicking human inputs by generating simulated human commands, the simulated human commands comprising synthetic voice commands and/or simulated iris gaze data,
wherein the on-site physical AI unit receives and executes the simulated human commands from the remote AI agent via the interface configured to receive the multi-modal human inputs.

2. The system of claim 1, wherein the system is deployed within a simulated training environment, and wherein the on-site physical AI provides multi-modal outputs of the environment including audio, video and/or haptic outputs.

3. The system of claim 2, wherein the remote AI control node generates a training event and the simulated human commands related to the training event.

4. The system of claim 2, wherein the remote AI agent generates the simulated human commands in response to teach the on-site physical AI unit how to react to an unpredictable physical world before physical actuation is required.

5. The system of claim 1, further comprising a Prompt Enhancement Module executed by the processor, wherein the Prompt Enhancement Module intercepts raw analog sensor data from the on-site physical AI unit and converts the raw analog sensor data into semantic text tokens prior to submission to a Large Language Model (LLM).

6. The system of claim 5, wherein the raw analog sensor data comprises simulated physical sense data generated during a synthetic training phase.

7. The system of claim 5, wherein the Prompt Enhancement Module converts the raw analog sensor data into the semantic text tokens by:
generating object detection tags for visual data;
analyzing acoustic data via Fast Fourier Transform (FFT) to generate frequency-descriptor tokens; and
converting vibration data into haptic intensity tokens.

8. The system of claim 5, wherein the Prompt Enhancement Module injects the semantic text tokens into a structured system prompt.

9. The system of claim 8, wherein the Prompt Enhancement Module detects danger tokens within the semantic text tokens and automatically pre-pends a stop work command to the structured system prompt to prioritize safety.

10. A computer-implemented method in a multimodal physical artificial intelligence (AI) system configured for human-mimicking teleoperation of physical AI, comprising:
receiving multi-modal inputs, from an on-site physical AI unit comprising a first processor and communicatively coupled to a data communication network, wherein the multi-modal inputs comprise one or more of real-time video, audio and haptic sensory data from a physical environment of the physical AI unit;
prompting a Large Language Model (LLM) to generate a training scenario for the physical AI; and
remotely controlling the on-site physical AI unit, with a remote AI control node comprising a second processor and communicatively coupled to the data communication network, by generating and sending simulated human commands from the training scenario that mimic human controls and comprise synthetic voice commands, simulated joystick movements and/or simulated iris gaze data,
wherein the on-site physical AI unit receives and executes the simulated human commands from the remote AI agent via an interface configured to receive the multi-modal human inputs, and
receiving multi-modal feedback of the physical Al execution of mimicked human controls.

11. A multimodal physical artificial intelligence (AI) system, comprising a non-transitory medium storing computer-executable code that, when executed by a processor, performs a method for human-mimicking teleoperation of physical AI, comprising:
receiving multi-modal inputs, from an on-site physical AI unit comprising a first processor and communicatively coupled to a data communication network, wherein the multi-modal inputs comprise one or more of real-time video, audio and haptic sensory data from a physical environment of the physical AI unit;
prompting a Large Language Model (LLM) to generate a training scenario for the physical AI; and
remotely controlling the on-site physical AI unit, with a remote AI control node comprising a second processor and communicatively coupled to the data communication network, by generating and sending simulated human commands from the training scenario that mimic human controls and comprise synthetic voice commands, simulated joystick movements and/or simulated iris gaze data,
wherein the on-site physical AI unit receives and executes the simulated human commands from the remote AI agent via an interface configured to receive the multi-modal human inputs, and
receiving multi-modal feedback of the physical Al execution of mimicked human controls.
